(19) United States
(12) Patent Application Publication
(10) Pub. No.: US 2014/0014043 A1
(43) Pub. Date: Jan. 16, 2014

(54) ANIMAL SCRATCHER

(71) Applicant: Pratt Industries, Inc., Conyers, GA (US)

(72) Inventor: Michael H. McCann, Kennesaw, GA (US)

(21) Appl. No.: 13/938,028

(22) Filed: Jul. 9, 2013

Related U.S. Application Data
(60) Provisional application No. 61/670,107, filed on Jul. 10, 2012.

(51) Int. Cl. A01K 15/02

(52) U.S. Cl. CPC A01K 15/024
USPC 119/706; 29/428

(57) ABSTRACT

An animal scratcher includes a unitary scratching board and an enclosure sized to accept at least a portion of the scratching board. A scratching board blank includes a plurality of sections, each section mechanically connected to another section; and at least one cut defined in the blank. A method of making a scratching board includes obtaining a blank; preparing at least one cut in the blank; folding the blank such that at least one cut is exposed and such that at least one scratching face is formed; and restraining the scratching board such that the scratching board is prevented from unfolding.

### REFERENCE TO RELATED APPLICATIONS

This application claims priority to U.S. Provisional Application No. 61/670,107, filed Jul. 10, 2012, which is hereby specifically incorporated by reference herein in its entirety.

### FIELD

This disclosure relates to pet products. More specifically, this disclosure relates to cat scratchers.

### BACKGROUND

Household pets provide companionship, but many also provide a source of stress for their owners. According to the Humane Society, there are approximately 86.4 million owned cats in the United States, and thirty-three percent of US households own at least one cat. A common source of frustration is the innate desire in many pets to scratch. Particularly with household cats, the desire to scratch often leads to destroyed furniture and household objects, some of which may be of high value.

### SUMMARY

Disclosed is an animal scratcher including a unitary scratching board and an enclosure sized to accept at least a portion of the scratching board.

Also disclosed is a scratching board blank includes a plurality of sections, each section mechanically connected to another section; and at least one cut defined in the blank.

Also disclosed is a method of making a scratching board includes obtaining a blank; preparing at least one cut in the blank; folding the blank such that at least one cut is exposed and such that at least one scratching face is formed; and restraining the scratching board such that the scratching board is prevented from unfolding.

### DESCRIPTION OF THE FIGURES

The features and components of the following figures are illustrated to emphasize the general principles of the present disclosure and are not necessarily drawn to scale. Corresponding features and components throughout the figures may be designated by matching reference characters for the sake of consistency and clarity.

FIG. 1 is a perspective view of an animal scratcher assembly in accord with one embodiment of the current disclosure.

FIG. 2 is a perspective view of an animal scratcher assembly in accord with one embodiment of the current disclosure.

FIG. 3a is a schematic view of a scratching board blank formable into a scratching board of the animal scratchers of FIGS. 1 and 2.

FIG. 3b is a side view of the scratching board blank of FIG. 3a being formed into the scratching board of the animal scratchers of FIGS. 1 and 2.

FIG. 4a is a schematic view of a scratching board blank formable into a scratching board in accord with one embodiment of the current disclosure.

FIG. 4b is a side view of a scratching board formed from the scratching board blank of FIG. 4a in accord with one embodiment of the current disclosure

FIG. 5a is a schematic view of a scratching board blank formable into a scratching board in accord with one embodiment of the current disclosure.

FIG. 5b is a side view of a scratching board formed from the scratching board blank of FIG. 5a in accord with one embodiment of the current disclosure

FIG. 6a is a schematic view of a scratching board blank formable into a scratching board in accord with one embodiment of the current disclosure.

FIG. 6b is a side view of a scratching board formed from the scratching board blank of FIG. 6a in accord with one embodiment of the current disclosure

FIG. 7a is a schematic view of a scratching board blank formable into a scratching board in accord with one embodiment of the current disclosure.

FIG. 7b is a side view of a scratching board formed from the scratching board blank of FIG. 7a in accord with one embodiment of the current disclosure

FIG. 8a is a schematic view of a scratching board blank formable into a scratching board in accord with one embodiment of the current disclosure.

FIG. 8b is a side view of a scratching board formed from the scratching board blank of FIG. 8a in accord with one embodiment of the current disclosure

FIG. 9a is a schematic view of a scratching board blank formable into a scratching board in accord with one embodiment of the current disclosure.

FIG. 9b is a side view of a scratching board formed from the scratching board blank of FIG. 9a in accord with one embodiment of the current disclosure

### DETAILED DESCRIPTION

Because of scratching, many pet owners experience a conflict between the love for their pets and the desire to maintain their personal possessions and furniture without damage. Various solutions to the problem have been introduced but are ineffective for various reasons.

One solution is a cat scratcher. A cat scratcher is typically an array of corrugated cardboard or some other generally porous, somewhat stiff, and somewhat textured material. In a typical cat scratcher product, a scratcher board is formed by aligning cardboard pieces face-to-face for a desired thickness, laminating the cardboard pieces, and cutting the laminated sheets with a band saw to form the scratching boards with the corrugations of the cardboard (also known as “flutes”) exposed on a scratching face to create a generally flat, porous surface. In some manufacturing processes, individual strips of cardboard are first cut and then glued together in this configuration. Typically, these products are several inches thick, several inches wide, and several inches deep such that there is ample surface for scratching. Cat scratchers of this variety may be industrially made or homemade. Although some commercial products exist, most are indistinguishable from homemade products. In use, a cat-owner places catnip inside the corrugations. The cat will scratch the cat scratcher in an attempt to reach the catnip trapped inside the scratcher. In this way, the cat-owner directs the cat's natural and innate desire for scratching to a product that is designed to be scratched rather than to furniture or other valuables. Often, the introduction of a cat scratcher will reduce the cat's interest in scratching elsewhere in the home.

However, cat scratchers of the current design are not typically commercially viable products and may be hazardous to cats. First, costs of manufacturing a cat scratcher are typically too high to justify a sales price that is attractive to buyers. A typical cat owner can usually find cardboard to cut and glue together with relatively little effort. A mass-producer will cut the strips of cardboard, align the strips in an array such that the corrugations are exposed, and use glue between each strip. Not only is such a configuration labor intensive, but it also includes glue as a secondary product that is usually ordered and purchased. The increased cost of production makes the commercial product relatively expensive, and many cat owners cannot justify the cost of such a product when it may be economically made at home.

Second, many glues introduce hazards to cats such that it is not desirable to use a glued product around a pet. When cats scratch the cat scratcher, the product slowly wears down. Particulate glue between the individual strips may be hazardous to cats. Many cat owners may not wish to expose their cats to potential hazards of toxic glues found in many cat scratcher products.

The current disclosure solves the problems of prior systems by providing an economically-produced cat scratcher product that is substantially free of glues and other hazardous materials and may be safely used to prevent destruction of household items by cats and other scratching pets. Disclosed are methods, systems, devices, and various apparatus related to a new and improved animal scratcher.

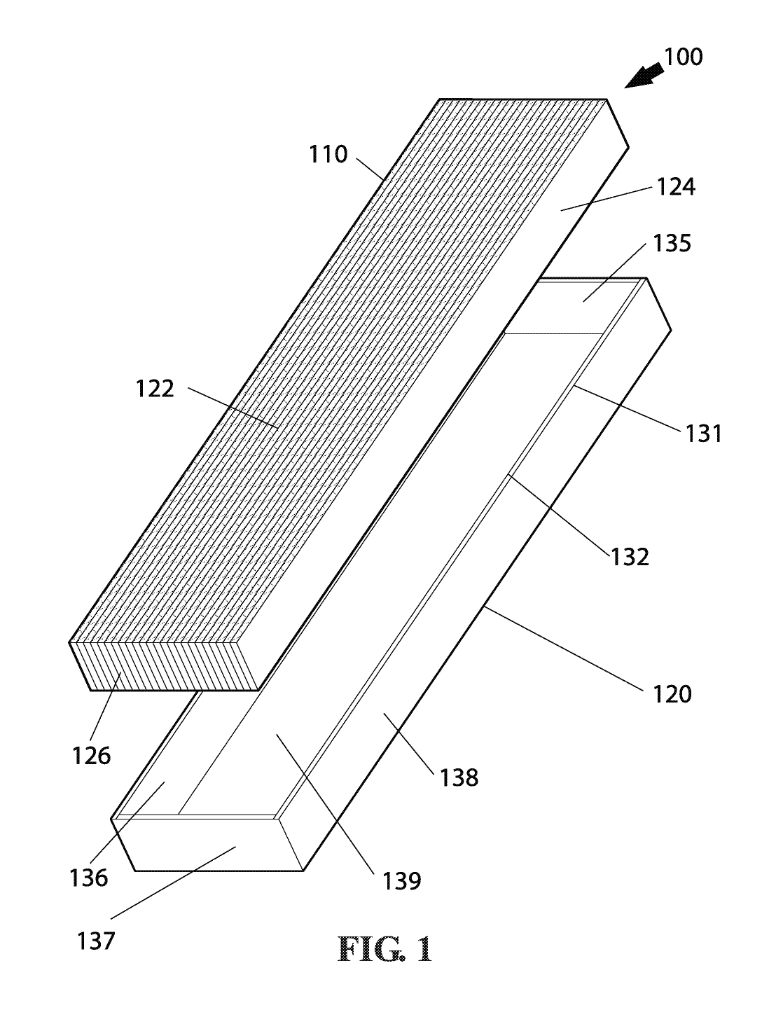

One embodiment of an animal scratcher 100 is shown in FIG. 1. The animal scratcher 100 includes a scratching board 110 and an enclosure 120. The scratching board 110 is made of corrugated cardboard in the current embodiment, although many different materials may be used in various embodiments of animal scratcher. The scratching board 110 of the current embodiment is a unitary board such that there are no separate and distinct pieces as may be found in prior designs. This provides several advantages, including easier manufacturability and safer end products.

The scratching board 110 includes a first scratching face 122. The first scratching face 122 is a face exposing the corrugations of the cardboard such that catnip or other desired materials may be placed inside the corrugations. The first scratching face 122 is exposed and is intended to be scratched by an animal. Orienting the scratching board 110 such that the corrugations are exposed not only allows catnip to be placed inside the scratching board 110 but also allows for the stiffest surface to be exposed, preventing easy destruction by the animal. A second scratching face 123 (not shown) may be disposed opposite the first scratching face 122 and may provide an alternative scratching face.

A first side 124 is seen in FIG. 1. A second side 125 is not seen but is opposite the first side 124. A first end 126 is also seen in FIG. 1. The first end 126 displays the sides of the corrugations. A second end 127 is not seen but is opposite the first end 126. In the current embodiment, the scratching board 110 is substantially rectangular in cross-section, although various shapes may be used. One of skill in the art would understand that the current disclosure is not limited to one specific shape.

The enclosure 120 is generally rectangular as well and includes a rectangular cavity 131 defined in a face 132 of the enclosure 120. The scratching board 110 is designed to fit into the cavity 131. In some embodiments, the scratching board 110 may be provided separately from the enclosure 120, so the scratching board 110 of the current embodiment is designed to fit within a usual enclosure such as enclosure 120. The enclosure 120 includes walls 135,136,137, 138 and a base 139. In some embodiments, the enclosure 120 may be produced by another producer for use with another product. The scratching board 110 may be sized to industry standards such that it may be used with various enclosures such as enclosure 120.

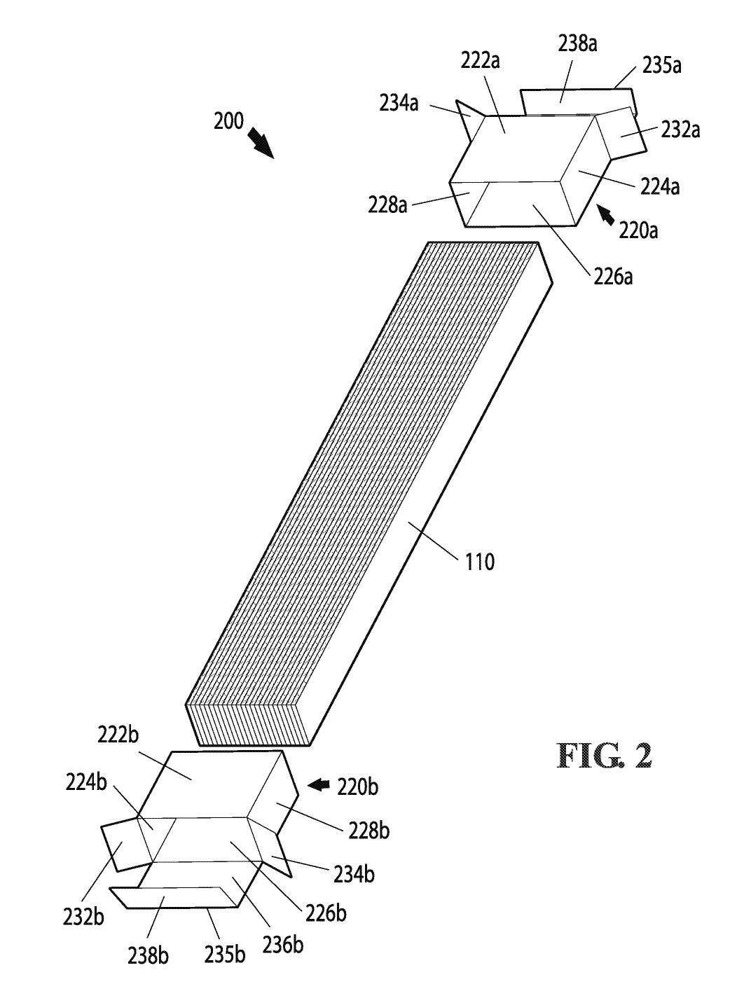

Another embodiment of an animal scratcher 200 is seen in FIG. 2. The animal scratcher 200 includes the scratching board 110 and end cap enclosures 220a,b. In the current embodiment, the end cap enclosures 220a,b each include a first wall 222a,b, a second wall 226a,b, a first side 224a,b, and a second side 228a,b. Fold tabs 232a,b, 234a,b fold over a cavity defined in the end cap enclosures 220a,b, and securing tabs 235a,b folds into the fold tabs 232a,b, 234a,b, respectively. The securing tabs 235a,b each include a cover portion 236a,b and a fold-in portion 238a,b. Although the end cap enclosures 220a,b are shown in this particular configuration, various configurations may be found in various embodiments, including end wraps (such as plastic wrap), mechanical enclosures (such as boxes formed of various materials), bolts or studs fit into holes in the ends, rubber bands or other elastic measures, and adhesives, among others. In some embodiments, various applications of materials may be applied to the ends only or to the entire scratching board. For example, an adhesive may be applied to the ends of the scratching board 110 to maintain its shape but not to introduce adhesive to an area that may be scratched by an animal. In another example, a rubber band or other mechanical constraint may be placed around the scratching board 110 such that it retains the shape of the scratching board at more than one location. One of skill in the art would understand that various enclosures may provide the benefit of retaining the shape of the scratching board 110 and are intended to be included in the disclosure.

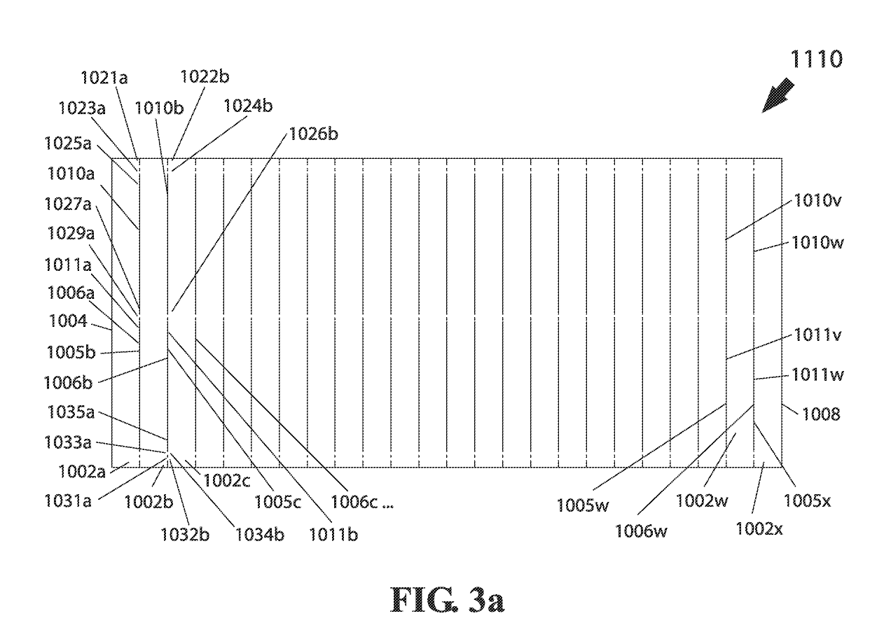

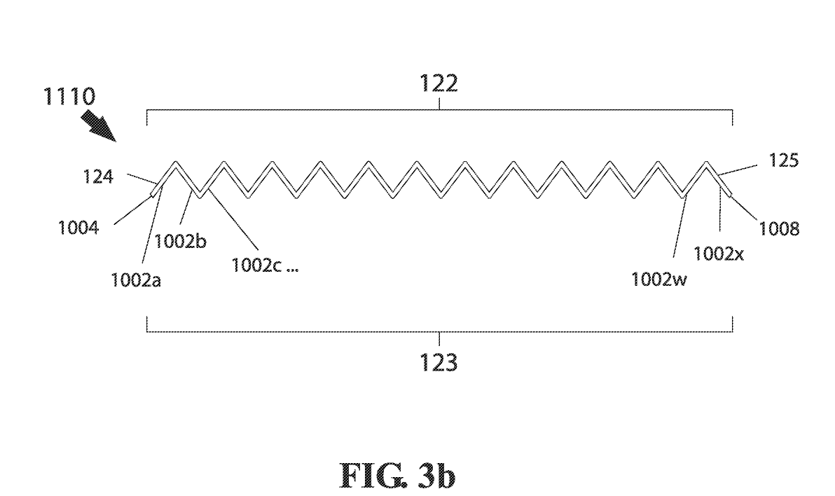

FIG. 3a shows a schematic view of a scratching board blank 1110 as a blank before being formed into the scratching board 110. The scratching board blank 1110 is a unitary piece of corrugated cardboard, though other materials may be used in other embodiments. The scratching board blank 1110 includes twenty-four sections 1002a-x. For clarity of drawing, ellipses are used where repeated elements occur from one section 1002 to another. One of skill in the art would understand that the disclosure is substantially the same for each section and, thus, additional reference elements are omitted to provide clarity of view. Similarly, in other FIGs., ellipses are used for repeated elements to prevent cluttering of view and to avoid unclear disclosure. One of skill in the art would understand that the elements discussed and pointed out in the current disclosure are repeated even if reference identifiers are not included for every instance of such feature.

The first section, section 1002a, includes a first end 1004. A second end 1006a is seen for the section 1002a. Each section 1002a-w includes a second end 1006a-w, respectively. The section 1002b includes a first end 1005b and the second end 1006b. Each section 1002b-x includes a first end 1005b-x, respectively, as seen with examples 1002c and 1002w, shown in FIG. 3a. Final section, section 1002x, includes first end 1005x and second end 1008. First end 1004 and second end 1008 also define the ends of the scratching board blank 1110. Between each first end 1005 and second end 1006 are various cuts, score lines, and attachments that allow the scratching board blank 1110 to bend more easily and to be formed into the scratching board 110.

Between each second end 1006a-w and each first end 1005b-x, respectively, are a first cut 1010a-w and a second cut 1011a-w, respectively. Each cut 1010,1011 provides the exposed surface such that the corrugations in the cardboard are exposed. Without the cuts 1010,1011, the corrugations would not be visible on the scratching faces 122,123.

Various score lines can also be seen in the view of FIG. 3a. Score lines 1021a, 1023a, 1025a, 1027a, 1029a, 1031a, 1033a, 1035a are proximate to the first cut 1010a and second cut 1011a as shown. Between score lines are connector tabs 1022b, 1024b, 1026b, 1032b, 1034b. The connector tabs 1022b, 1024b, 1026b, 1032b, 1034b are shown with reference to cuts 1010b and 1011b to prevent cluttering the view with reference to cuts 1010a and 1011a. However, connector tabs 1022a, 1024a, 1026a, 1032a, 1034a are included proximate to and between score lines 1021a, 1023a, 1025a, 1027a, 1029a, 1031a, 1033a, 1035a as well, although they are not specifically called out in the figure for clarity of view. Similarly, score lines 1021b-w, 1023b-w, 1025b-w, 1027b-w, 1029b-w, 1031b-w, 1033b-w, and 1035b-w are proximate the first cuts 1010b-w and the second cuts 1011b-w, respectively, and connector tabs 1022b-w,1024b-w,1026b-w,1032b-w,1034b-w are proximate score lines 1021b-w, 1023b-w, 1025b-w, 1027b-w, 1029b-w, 1031b-w, 1033b-w, and 1035b-w, respectively. Reference characters related to such features have been omitted from the view of FIG. 3a because such characters would be substantially repetitive while cluttering the view of the figure. One of skill in the art would understand that the score lines 1021b-w, 1023b-w, 1025b-w, 1027b-w, 1029b-w, 1031b-w, 1033b-w, 1035b-w and connector tabs 1022b-w, 1024b-w, 1026b-w, 1032b-w, 1034b-w would be repeated for the junction of each section 1002a-w with another section 1002b-x.

FIG. 3b shows a side view of the scratching board blank 1110 in assembly to become the scratching board 110. The scratching board blank 1110 is folded along each joint between one section 1002a-w with another section 1002b-x, respectively, such that the folding resembles an accordion. Cuts 1010a-w, 1011a-w allow the corrugations of the cardboard to be exposed to form scratching faces 122,123. A first side of section 1002a becomes the first side 124 of the scratching board 110 and a first side of section 1002x becomes the second side 125 of the scratching board 110. Score lines 1021b-w, 1023b-w, 1025b-w, 1027b-w, 1029b-w, 1031b-w, 1033b-w, 1035b-w and connector tabs 1022b-w, 1024b-w, 1026b-w, 1032b-w, 1034b-w keep the sections 1002a-x mechanically connected together so that the scratching board 110 need not use glue or other adhesive to stay together. Instead, only a mechanical constraint-such as enclosure 120 or end cap enclosures 220a,b—is needed to hold the sections 1002a-x from springing apart. In some embodiments, adhesive may be used on at least part of the scratching board 110 to prevent the sections 1002a-x from springing apart.

Scratching board blanks 1110 of the current disclosure are cut using die cut patterns. Animal scratchers of prior designs are typically made using band saws, which may introduce hazardous materials such as heavy metals into the cutting environment. By die cutting, potentially hazardous materials are eliminated from the production process, thereby limiting the potential that an animal will be exposed to such hazardous materials upon use of the animal scratcher 100 or of the scratching board 110.

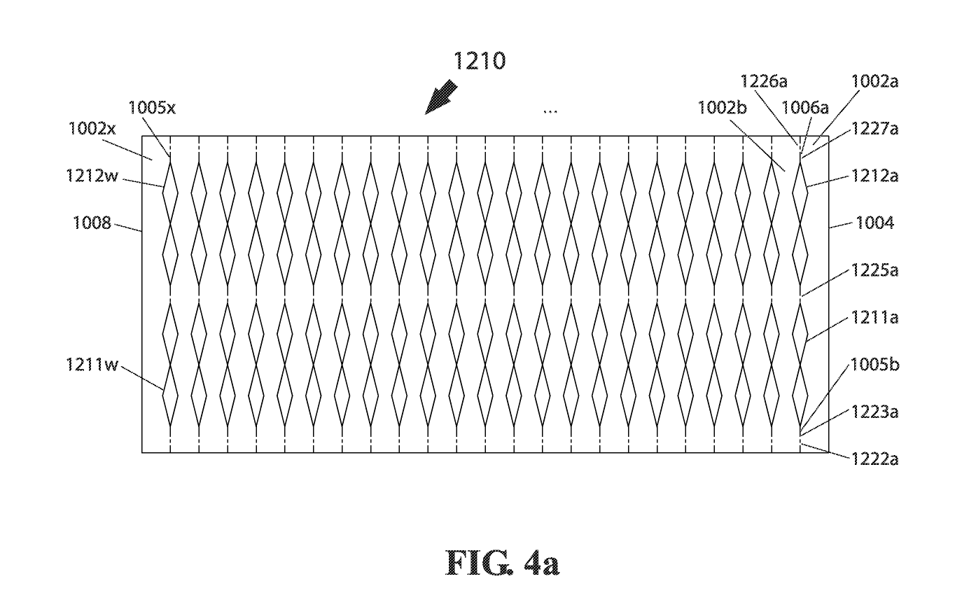

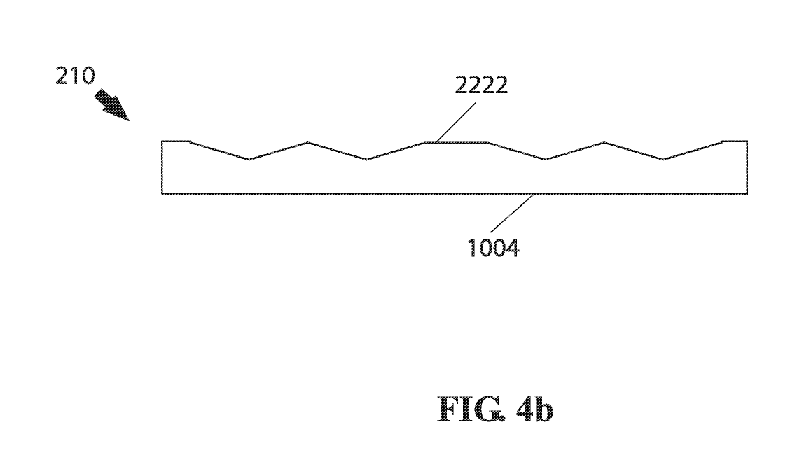

FIG. 4a displays a schematic view of another embodiment of a scratching board blank 1210. The scratching board blank 1210 includes sections 1002a-x. First ends 1005b-x and second ends 1006a-w are included with each section as indicated elsewhere with reference to scratching board blank 1110. The scratching board blank 1210 includes first cuts 1211a-w and second cuts 1212a-w each located between one section 1002a-w and another section 1002b-x, respectively. Each cut 1211a-w, 1212a-w in the current embodiment is a double-diamond shaped cut. Score lines 1223a-w, 1225a-w, and 1227a-w are seen, as are connection tabs 1222a-w, 1226a-w.

As seen in the side view of FIG. 4b, the scratching board blank 1210 may be formed into a scratching board 210 by folding along each joint between one section 1002a-w with another section 1002b-x, respectively, as described previously with respect to scratching board blank 1110. The side view of FIG. 4b shows that, when assembled, a first scratching face 2222 includes a texture pattern of peaks and valleys corresponding with the shape of the cuts 1211,1212. Although a flat line is seen from the side view representing first end 1004, a second scratching face (not shown) includes a profile complementary to the first scratching face 2222. In the current embodiment, the first end 1004 and the second end 1008 are included for several reasons. First, the first end 1004 and second end 1008 provide guidance for placement of the scratching board 210 into an enclosure—such as enclosure 120—and provide the scratching board 210 a tight, square fit in the enclosure, whereas a textured surface may rock or tilt or may not be secured as easily within such an enclosure. Second, the first end 1004 and second end 1008 allow for easier manufacturing because the squared ends 1004,1008 allow simpler palletization. Palletization refers to the “squaring up” of a number of such scratching board blanks 1210 (or 1110, or those disclosed elsewhere herein) such that they can be stacked, shrinkwrapped, shipped, or otherwise handled by machinery in a standardized way without the need for special machinery or handling procedures. However, in some embodiments, the square shape of the first end 1004 and second end 1008 may be omitted in favor of a texture.

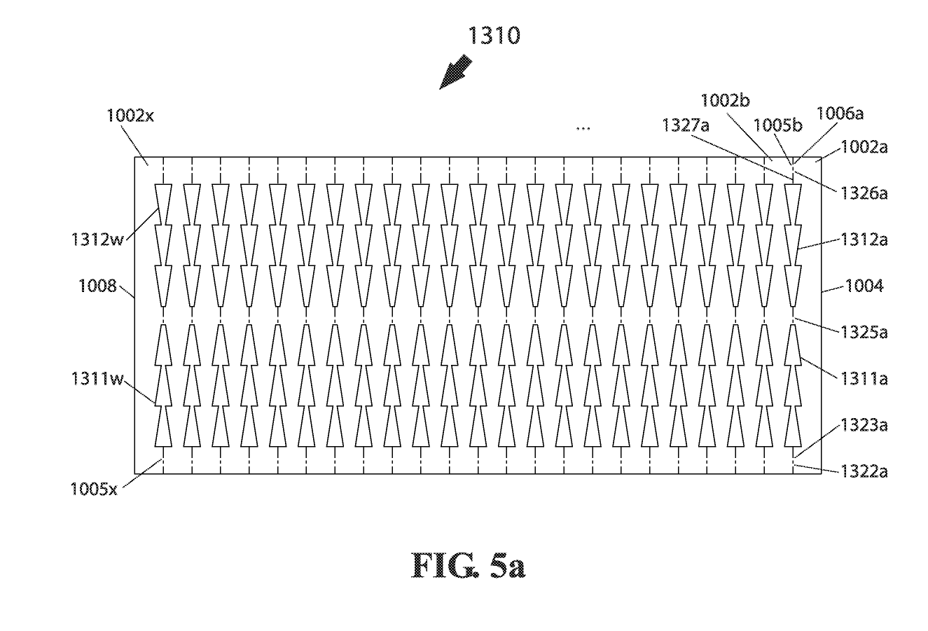

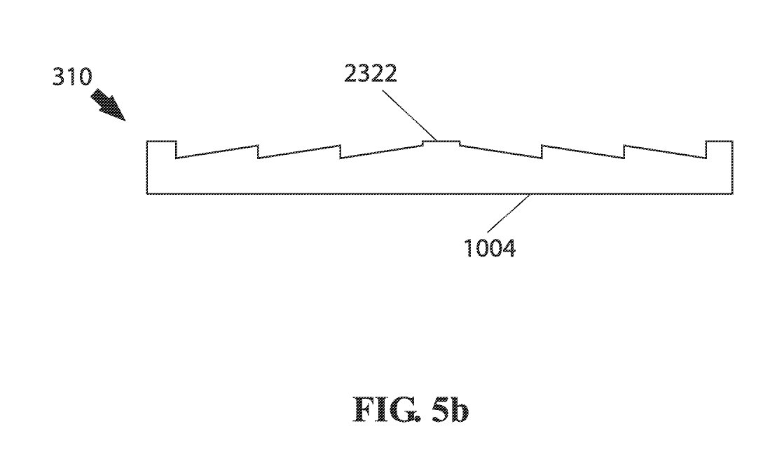

Another embodiment of a scratching board blank 1310 is seen in FIG. 5a. The scratching board blank 1310 includes cuts 1311a-w, 1312a-w as well as score lines 1323a-w, 1325a-w, 1327a-w and connection tabs 1322a-w, 1326a-w. Each cut 1311a-w, 1312a-w in the current embodiment is a Christmas tree-shaped cut. A side view of a scratching board 310 formed from the scratching board blank 1310 can be seen in FIG. 5b. A first scratching face 2322 is seen to show the profile created by cuts 1311a-w, 1312a-w.

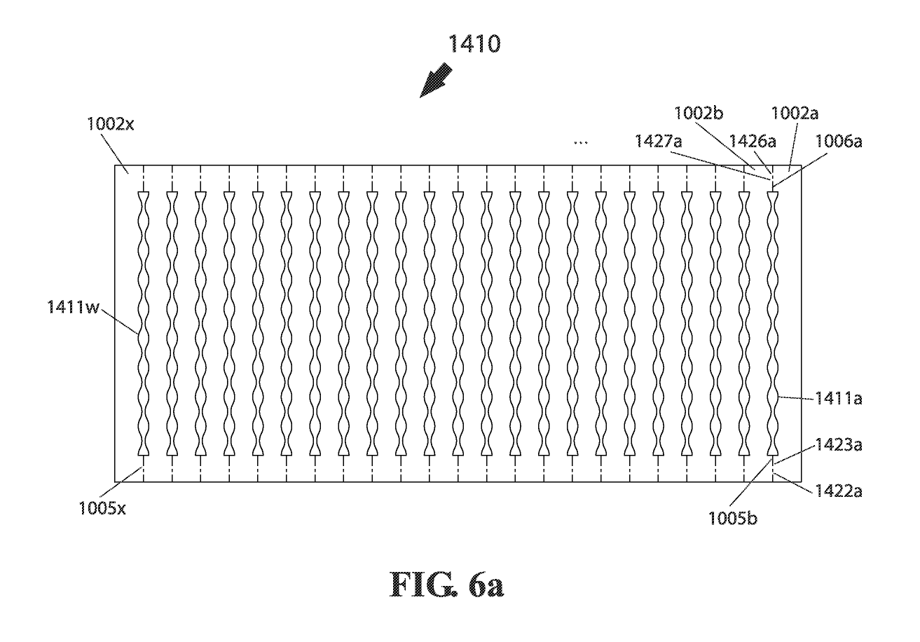

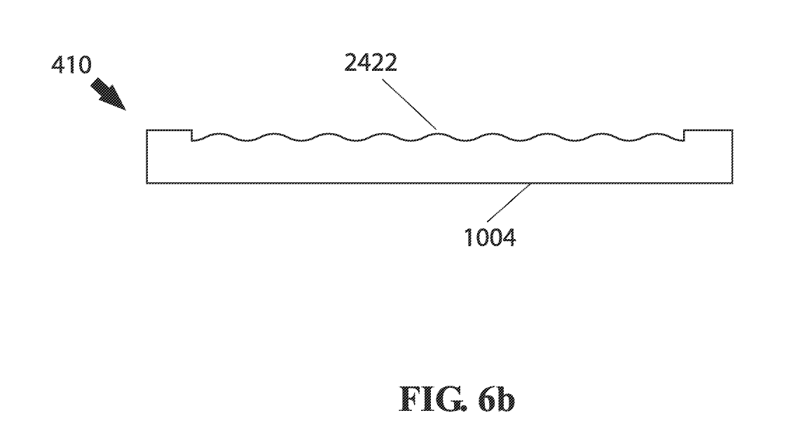

Another embodiment of a scratching board blank 1410 is seen in FIG. 6a. The scratching board blank 1410 includes cuts 1411a-w as well as score lines 1423a-w, 1427a-w and connection tabs 1422a-w, 1426a-w. Each cut 1411a-w in the current embodiment is a wave-shaped cut. A side view of a scratching board 410 formed from the scratching board blank 1410 can be seen in FIG. 6b. A first scratching face 2422 is seen to show the profile created by cuts 1411a-w.

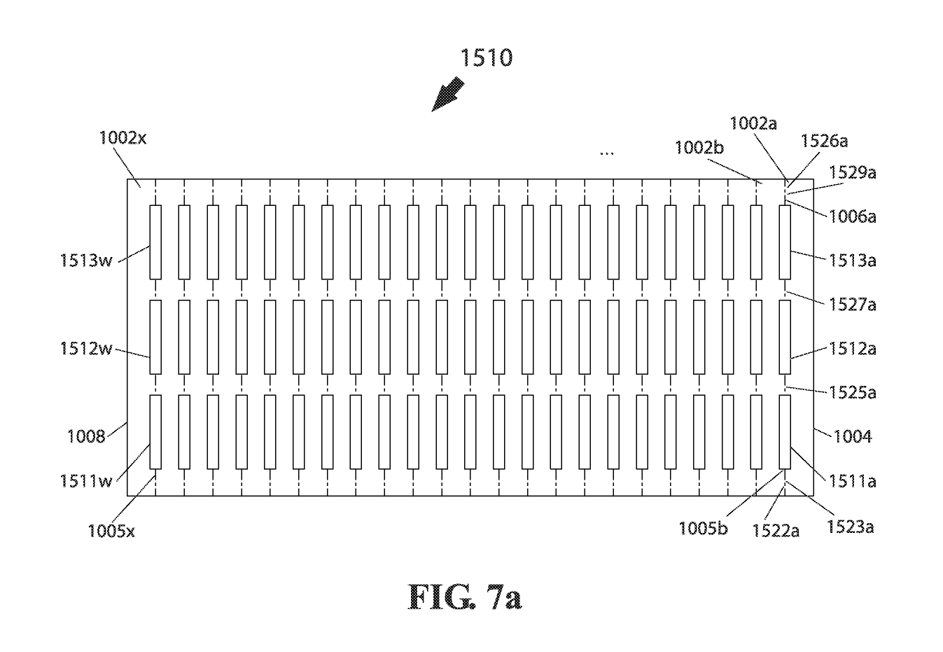

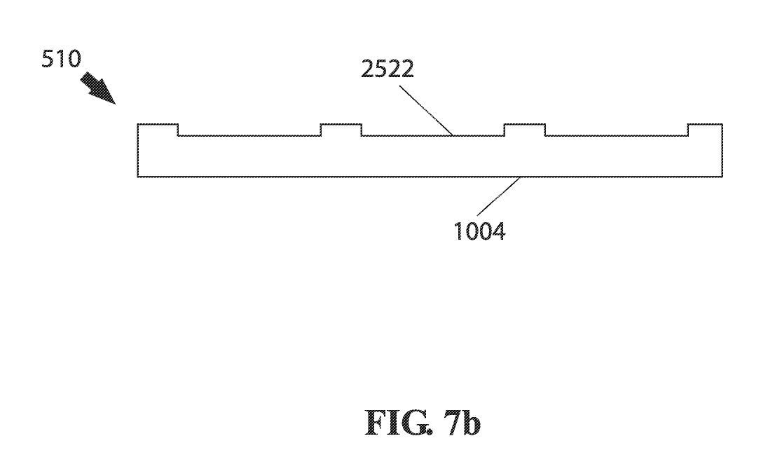

Another embodiment of a scratching board blank 1510 is seen in FIG. 7a. The scratching board blank 1510 includes cuts 1511a-w, 1512a-w, 1513a-w as well as score lines 1523a-w, 1525a-w, 1527a-w, 1529a-w and connection tabs 1522a-w, 1526a-w. Each cut 1511a-w, 1512a-w, 1513a-w in the current embodiment is a rectangular shaped cut. A side view of a scratching board 510 formed from the scratching board blank 1510 can be seen in FIG. 7b. A first scratching face 2522 is seen to show the profile created by cuts 1511a-w, 1512a-w, 1513a-w.

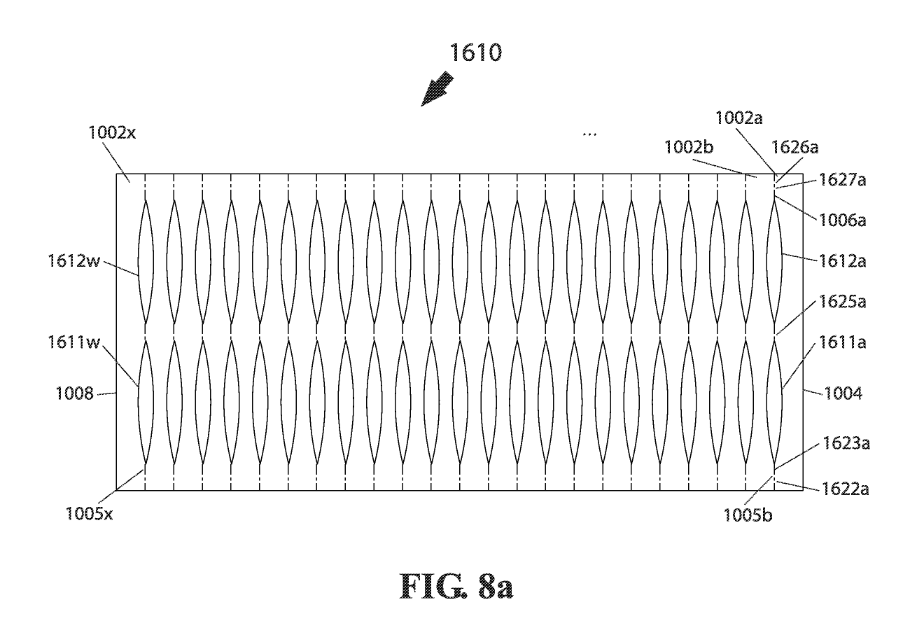

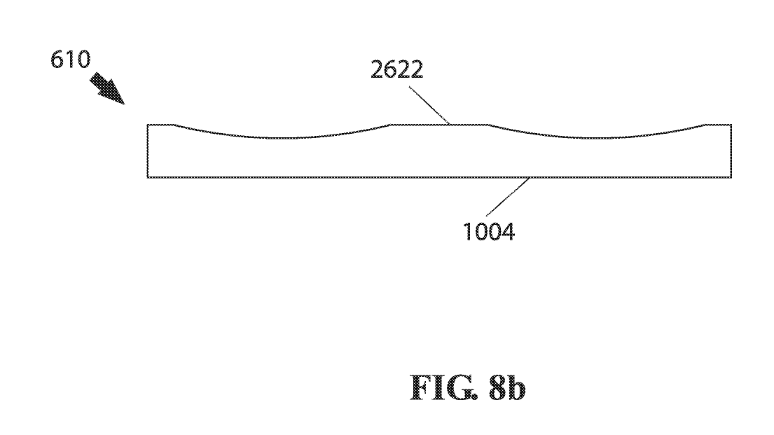

Another embodiment of a scratching board blank 1610 is seen in FIG. 8a. The scratching board blank 1610 includes cuts 1611a-w, 1612a-w as well as score lines 1623a-w, 1625a-w, 1627a-w and connection tabs 1622a-w, 1626a-w. Each cut 1611a-w, 1612a-w in the current embodiment is an oblong cut or eyelid-shaped cut. A side view of a scratching board 610 formed from the scratching board blank 1610 can be seen in FIG. 8b. A first scratching face 2622 is seen to show the profile created by cuts 1611a-w, 1612a-w.

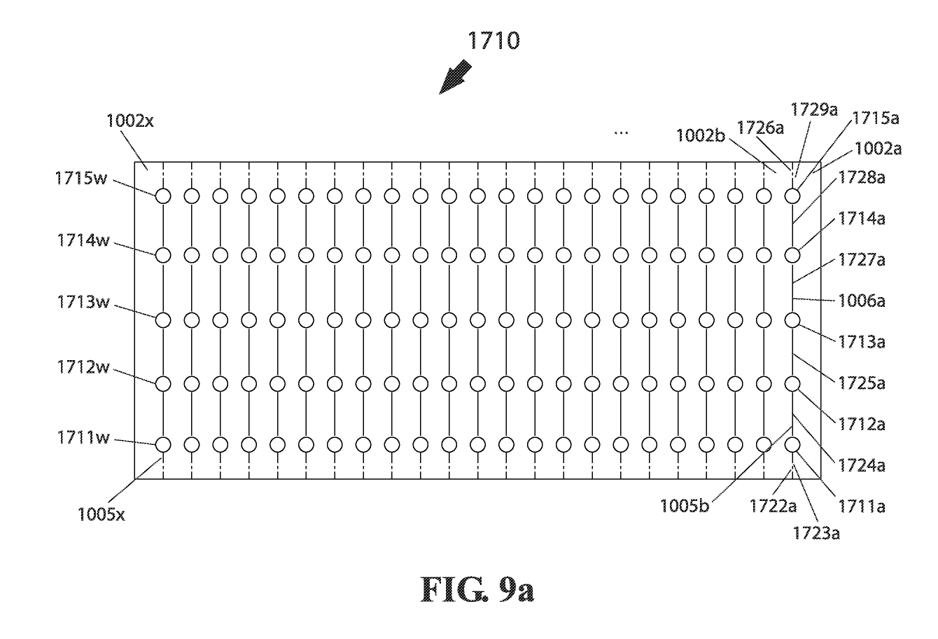

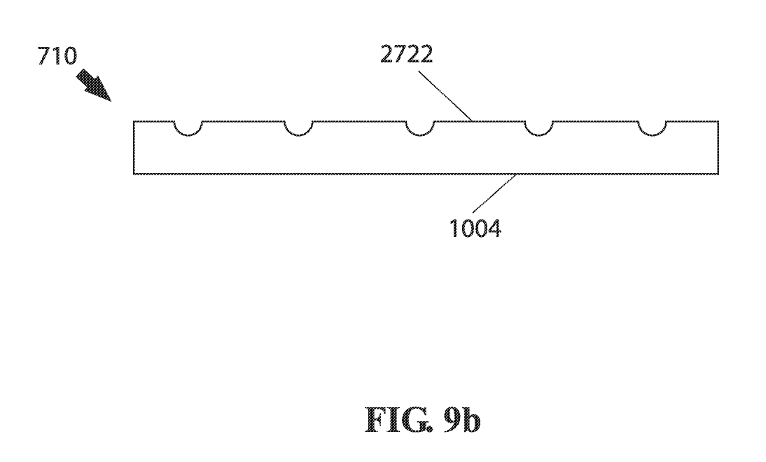

Another embodiment of a scratching board blank 1710 is seen in FIG. 9a. The scratching board blank 1710 includes cuts 1711a-w, 1712a-w, 1713a-w, 1714a-w, 1715a-w, as well as score lines 1723a-w, 1724a-w, 1725a-w, 1727a-w, 1728a-w, 1729a-w, and connection tabs 1722a-w, 1726a-w. Each cut 1711a-w, 1712a-w, 1713a-w, 1714a-w, 1715a-w in the current embodiment is round or circular cut. A side view of a scratching board 710 formed from the scratching board blank 1710 can be seen in FIG. 9b. A first scratching face 2722 is seen to show the profile created by cuts 1711a-w, 1712a-w, 1713a-w, 1714a-w, 1715a-w.

Each scratching board 110,210,310,410,510,610,710 is formed by bending each scratching board blank 1110,1210,1310,1410,1510,1610,1710, respectively, along the various scoring lines and cuts as disclosed herein with respect to FIGS. 3a-9b. Each section 1002a-x is folded with respect to adjacent sections 1002a-x such that the sections 1002a-x fold back on each other. This arrangement is illustrated with reference to FIG. 3b. When the sections 1002a-x are folded such that their surfaces are aligned, the scratching board blank 1110,1210,1310,1410,1510,1610,1710 is transformed into the scratching board 110,210,310,410,510,610,710, respectively. The scratching board 110,210,310, 410,510,610,710 may then be used with an enclosure such as enclosure 120, end cap enclosures 220a,b, or another type of enclosure as previously described.

In some embodiments, the animal scratcher 100,200 (and various modifications to animal scratcher 100,200 as disclosed herein) or the scratching board 110,210,310,410,510,610,710 individually may be provided in a shrinkwrapped packaging. In some embodiments, the shrinkwrapped packaging may provide at least part of the enclosure. In various embodiments, catnip or other similar animal product may be provided within the packaging. Other packaging may also be used in various embodiments.

This disclosure represents one of many possible assembly configurations. One skilled in the art will understand obvious variations of this disclosure are intended to be included, including variations of steps, combinations of steps, and dissections of steps, among others. Where materials are chosen for the elements of this assembly, similar material choices may also be used and would be obvious to one in the art.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

Various implementations described in the present disclosure may include additional systems, methods, features, and advantages, which may not necessarily be expressly disclosed herein but will be apparent to one of ordinary skill in the art upon examination of the detailed description and accompanying drawings. It is intended that all such systems, methods, features, and advantages be included within the present disclosure and protected by the accompanying claims.

That which is claimed is:

1. An animal scratcher comprising:
a unitary scratching board; and
an enclosure sized to accept at least a portion of the scratching board.

2. The animal scratcher of claim 1, wherein the enclosure defines a cavity, the scratching board sized to fit within the cavity.

3. The animal scratcher of claim 1, wherein the scratching board is formed from a scratching board blank including at least one scratching face.

4. The animal scratcher of claim 3, wherein the scratching board includes at least one cut.

5. The animal scratcher of claim 3, wherein the scratching board includes a plurality of sections, each section including a first end and a second end, each section mechanically connected to another section.

6. The animal scratcher of claim 5, wherein the enclosure is sized to accept the first end of each of the plurality of sections.

7. The animal scratcher of claim 6, further comprising a second enclosure, the second enclosure sized to accept the second end of each of the plurality of sections.

8. The animal scratcher of claim 5, wherein each section of the plurality of sections is rectangular.

9. The animal scratcher of claim 5, wherein the scratching board includes at least one cut between at least two of the plurality of sections.

10. The animal scratcher of claim 5, wherein each section is mechanically connected to another section by at least one connector tab.

11. The animal scratcher of claim 10, wherein each connector tab is formed between a pair of cuts.

12. A scratching board blank comprising:
a plurality of sections, each section mechanically connected to another section; and
at least one cut defined in the blank.

13. The scratching board blank of claim 12, wherein the at least one cut is a plurality of cuts.

14. The scratching board blank of claim 13, wherein the plurality of cuts form at least one connector tab between a first section of the plurality of sections and a second section of the plurality of sections.

15. The scratching board blank of claim 12, wherein the at least one cut is diamond-shaped, Christmas tree-shaped, wave-shaped, rectangular-shaped, eyelid-shaped, or circular.

16. The scratching board blank of claim 12, wherein each section of the plurality of sections is rectangular.

17. A method of making a scratching board comprising:
obtaining a blank;
preparing at least one cut in the blank;
folding the blank such that at least one cut is exposed and such that at least one scratching face is formed; and
restraining the scratching board such that the scratching board is prevented from unfolding.

18. The method of claim 17, wherein restraining the scratching board such that the scratching board is prevented from unfolding includes placing at least a portion of the scratching board within an enclosure.

19. The method of claim 17, wherein preparing at least one cut in the blank includes preparing a plurality of cuts in the blank, the plurality of cuts defining at least one connector tab between a first section of the blank and a second section of the blank.

20. The method of claim 17, wherein:
the blank includes a plurality of sections, each section mechanically connected to another section;
the at least one cut is a plurality of cuts, each cut of the plurality of cuts between each section of the plurality of sections; and
wherein folding the blank includes forming a pair of scratching surfaces from the plurality of cuts.
